(19) United States
(12) Patent Application Publication
(10) Pub. No.: US 2008/0065533 A1
(43) Pub. Date: Mar. 13, 2008

(54) TRANSACTION MANAGEMENT SYSTEM AND METHOD

(75) Inventors: Gordon J. Whiting, Oakland, CA (US); Melvin Scott Lloyd, Oakland, CA (US); Gregory M. Kerwin, Oakland, CA (US)

Correspondence Address: DAVIS WRIGHT TREMAINE, LLP/Seattle, 1201 Third Avenue, Suite 2200, SEATTLE, WA, 98101-3045, US

(73) Assignee: SETTLENET, INC., Oakland, CA (US)

(21) Appl. No.: 11/854,503

(22) Filed: Sep. 12, 2007

Related U.S. Application Data
(60) Provisional application No. 60/825,388, filed on Sep. 12, 2006.

(51) Int. Cl. G06Q 40/00

(52) U.S. Cl. 705/39

(57) ABSTRACT

A transaction management system facilitates online monetary transactions between users of the system. These transactions are settled as associated with standard inter-banking settlement channels. Implementations of the system provide for a relatively simple yet flexible transaction processing technology to the online market space. The system allows for integration into a plethora of end user online applications and services with backend financial industry infrastructures.

### BACKGROUND OF THE INVENTION

1. Field of the Invention

The present invention is directed generally to financial transaction systems.

2. Description of the Related Art

Fraud, identify theft, and other problems can be associated with conventional commerce and other types of monetary transactions.

### BRIEF DESCRIPTION OF THE SEVERAL VIEWS OF THE DRAWING(S)

FIG. 1 is a circuit flow diagram for a purchase transaction according to the present invention.

FIG. 2 is a circuit flow diagram for a fund transfer transaction according to the present invention.

FIG. 3 depicts the hardware architecture of a system that can be involved with implementation of the system and method.

### DETAILED DESCRIPTION OF THE INVENTION

Described herein is a transaction management system. The system facilitates online monetary transactions between users of the system. These transactions are settled as associated with standard inter-banking settlement channels. Implementations of the system provide for a relatively simple yet flexible transaction processing technology to the online market space. The system allows for integration into a plethora of end user online applications and services with backend financial industry infrastructures.

Definitions:

User:

Users of the system include individuals or business entities that have opened a financial account (e.g. a credit account or a deposit account) with a financial institution (referred herein as a financial agent) for the purpose of processing monetary transfers from one of the users to another of the users.

Implementations of the system provide capability for one of the users to both receive and send payments to any other of the users in a convenient and timely manner. If desired, there can be little if any account distinction between users sending or receiving monetary amounts via the system thereby streamlining setup and implementation.

Financial Agents:

Financial agents are authorized financial institutions that hold user accounts on proprietary servers attached to the Internet. The financial agents are licensed to communicate with transaction servers as described further below. Servers associated with the financial agents maintain account balance and transaction information for each of the users and are responsible for processing transaction authorization requests from the transaction serversTransaction Servers:

The transaction servers are a collection of distributed servers that receive and process transaction requests.

Transactions:

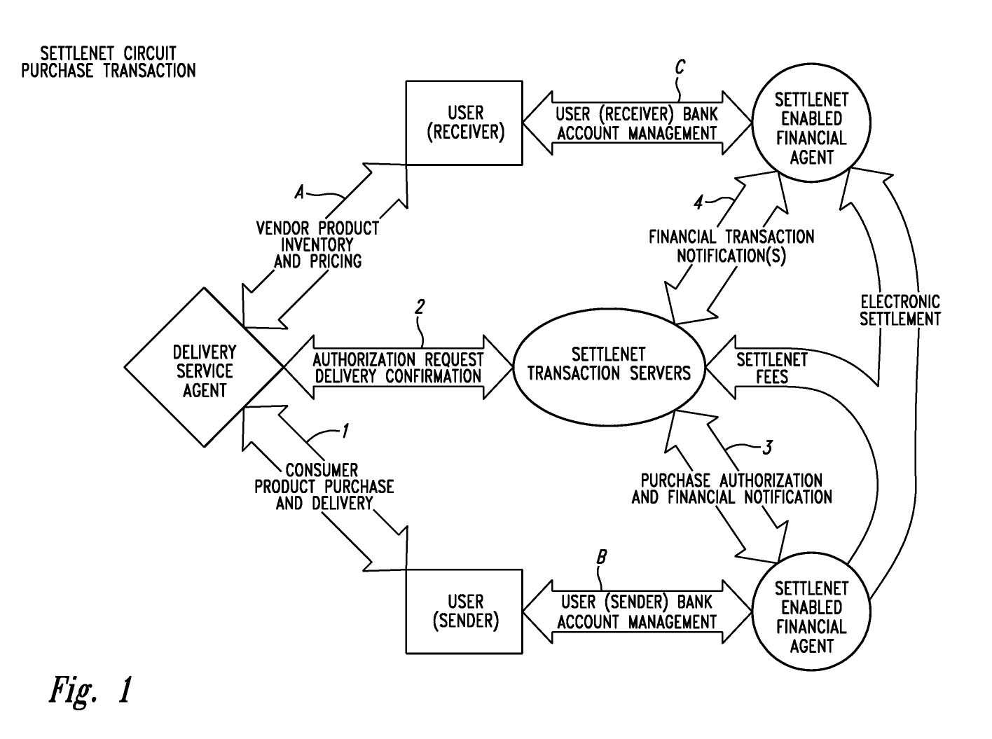

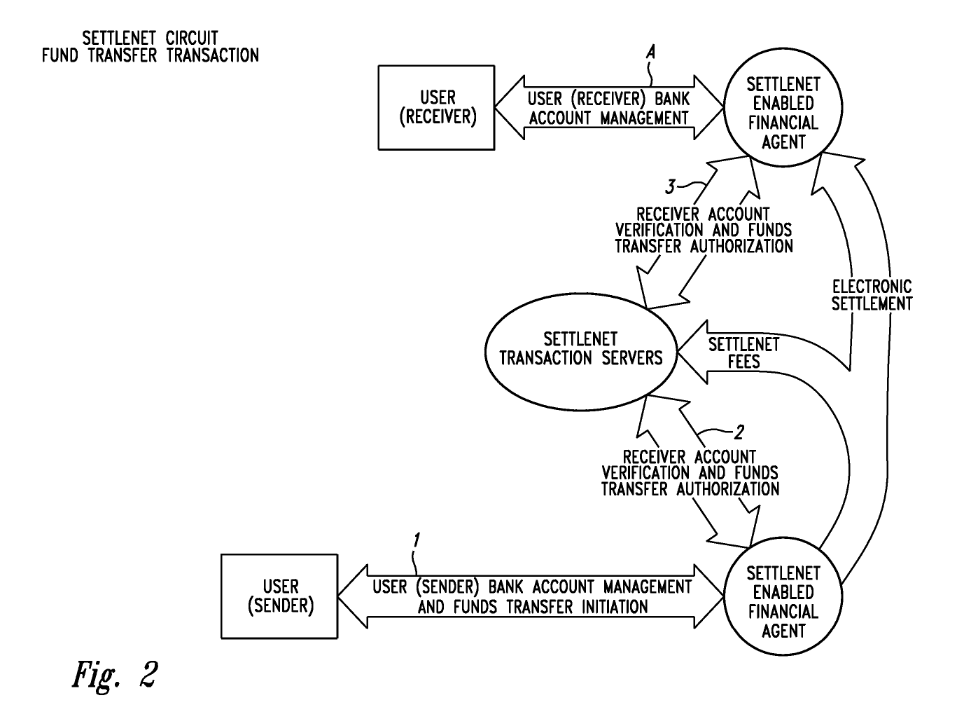

Transactions in the system include a monetary transfer of legal tender between a sender (referred to herein as a “sending user”) and a receiver (referred to herein as a “receiving user”), both of which being users of the system. A receiving user is a logical entity that is expected to receive a monetary amount resulting from one of the transactions. The receiving user can include a business enterprise selling a product or service to an individual receiving money from another of the users acting as the sending user. The sending user is a logical entity that is expected to send a monetary amount to a receiving user for either a purchase of a product or service or as a direct transfer of funds. There are at least two types of transactions involved with the system: a purchase transaction, shown in FIG. 1, and a funds transfer transaction, shown in FIG. 2.

Purchase Transaction:

The purchase transaction generally is involved when the receiving user, such as a merchant, wants to verify authorization of payment by a sending user, such as a buyer, prior to fulfillment of a product purchase, service request, or other purchases by the sending user.

Once the receiving user of a particular purchase transaction obtains payment authorization from the transaction servers, the receiving user is thereafter guaranteed payment contingent upon confirmation of order fulfillment, such as by confirmation of a product delivery. The purchase transaction can be used for orders involving online electronic content and/or service purchases, which can represent the purchase of anything from website content to time on an online gaming server. The purchase transaction can also involve purchases of real goods shipped over standard shipping channels.

Funds Transfer Transaction:

The funds transfer transaction, shown in FIG. 2, as mentioned above, is a second type of transaction handled by the system. This type of transaction results directly from the interaction of one of the sending users with one of the financial agents where both are using the system. In certain instances, the funds transfer transaction can be used in place of a conventional wire transfer. Since there is no order fulfillment as described above with the purchase transaction, the funds transfer transaction is generally processed relatively quickly and does not typically involve a delivery service agent entity as described further below.

Transaction Settlement:

All transactions are settled between the various financial agents typically on a batch process basis, which typically can be performed nightly. Due to a general condition that the financial institutions are guarantors of the transactions, in any particular case, the financial institution representing the receiving user can reliably credit an account involved in the transaction of the receiving user in at least near real-time. With each receiving user account being credited, a guarantee exists that appropriate funds will be transferred to the financial agent of the receiving user during the next occurring batch settlement process.

Furthermore, during the batch settlement process, each of the financial agents representing at least one of the sending users (referred herein as “sending user financial agent”) will group funds of the purchase transactions and of the funds transfer transactions according to the financial agents representing at least one of the receiving users (referred to herein as “receiving user financial agents”). An accumulated inter-bank payments clearing and settlement transaction (referred to herein as “inter-bank settlement transaction”) for each grouping of funds by each of the sending user financial agents will then be sent from the sending user financial agent to each of the respective receiving user financial agents. Each of the inter-bank settlement transactions may be a separate settlement transfer or may be merged by the sending user financial agent with an on-going routine settlement transfer (e.g. a check clearing settlement) that may already exist between each different pair of the sending user financial agents and the receiving user financial agents.

Delivery Service Agent:

Delivery service agents (delivery service agent) are online services that perform delivery tasks for a receiving user such as a merchant. The delivery service agents are generally licensed and authorized to deliver content as associated with the system. The delivery service agents only initiate delivery and confirmation transactions to facilitate purchases. Once a payment authorization has been returned to a delivery service agent from one of the transaction servers, the delivery service agent is responsible for confirming delivery of an associated product or other ordered item or service to the sending user via a computer typically used to place the order. Once delivery has been verified, the delivery service agent notifies the associated transaction server with the final status of delivery. In turn, the transaction server closes out the particular transaction.

Delivery service agents are not required to be a separate business entity from a receiving user; however, the delivery service agent is distinctly identified as a separate functional entity of the system being separate from the receiving users of the system. For instance, if a receiving user, such as a merchant, is licensed to perform delivery service agent functions, in some implementations, the receiving user could also act as their own delivery service agent if desired.

As discussed above, each of the funds transfer transactions occurs between one of the sending user financial agents and one of the receiving user financial agents. Consequently, the delivery service agent is inherently not involved with funds transfer transactions.

Purchase Thresholds:

Purchase thresholds are spending limits that can be predefined by each of the sending users. If the purchase thresholds are exceeded by either one or several transactions, a real-time confirmation dialog is sent to the sending user. A transaction amount under the purchase thresholds is impliedly treated as being authorized and is consequently considered to be acceptable without requiring specific authorization by the sending user.

The purchase thresholds are generally predefined according to specific defined scoping rules. For example, a purchase threshold regarding a single webpage might pertain to the cost of a single page view transaction. In contrast, a purchase threshold regarding a session might pertain to the total browsing session of a sending user starting when a browser being used by the sending user is opened and ending when the browser being used by the sending user is closed. The number of scoping rules for these thresholds can potentially be quite large.

Some examples of the purchase thresholds can include but are not limited to the following:

| | |
|---|---|
| Type: | Web Page Viewing |
| Thresholds: | Max Amount Per Webpage |
| | Max Amount Per Browsing Session |
| Type: | Email Sending |
| Thresholds: | Max Amount Per Email |
| | Max Amount Per Day |
| Type: | Gaming Services or Streaming Data |
| Thresholds: | Max Amount Per Hour |
| | Max Amount Per Day |
| | Max Amount Per Week |
| | Max Amount Per Month |
| | Max Amount Per N Bytes |
| Type: | VoIP |
| Thresholds: | Max Amount Per Call |
| | Max Amount Per Billing Cycle |

Assumptions:

Given the sensitive nature of the transactions, users of the system use a client application directed toward processing transactions with improved security. Typically a requirements document is published for supported client applications. For enhanced security, the client applications adhere to the requirements document to successfully interact with the transaction servers and/or the delivery service agent entities.

The client applications involved with the system have a wide spectrum of application through various technologies and markets. Although the present depicted exemplary implementations focus on particular markets, the exemplary implementations are provided for illustration and are not intended to be limiting.

Purchase Transaction Implementation

Purchase transactions are processed through the system using a proprietary protocol between the various process entities involved. FIG. 1 shows a schematic view of relationships and a general process associated with the system to support the purchase transactions.

The following is an abstract description of each process step the details of which will be defined in subsequent documentation.

Interaction A of FIG. 1:

The receiving user, such as a merchant, updates the associated delivery service agent servers with information concerning products being offered to potential buyers. The information includes financial agent account information as well as pricing models for the goods being offered for sale. The pricing models can be rule-based and may include standard flat rate pricing or may have additional predictive functions, such as volume or user class discounts according to input by the receiving user.

Pricing may include a wide range of levels from, for instance, a thousandths of a penny to thousands of dollars. In the exemplary implementation, real-world market considerations can be used to exclusively determine ranges of price. Although theoretically, price ranges could have an excessive amount of variability, in practice the price ranges fall well within technical capacity of the system.

Once the delivery service agent servers are updated, products are sold through the system with little or no further maintenance requirement needed by the system from the receiving user. Furthermore, some information being updated on the delivery service agent servers may be provided by automated processes and may not necessarily be manually inputted by the receiving user.

Interaction B of FIG. 1:

In order for a sending user (e.g. a buyer) to initiate a purchase transaction, the sending user must log into an associated financial agent of the sending user. Once logged in, the sending user will have access to not only real-time purchase totals and information but also the sending user will have the ability to define and maintain the associated purchase thresholds as described. Further the sending user is able to view purchase history and perform any auxiliary tasks made available to them through the account maintenance tools.

In addition to allowing for account maintenance the connection to the financial agent also serves to authenticate the sending user and offers additional security and notification capabilities during the processing of a purchase request from the sending user (e.g. a buyer).

Interaction C of FIG. 1:

Unlike the sending user (e.g. a buyer), the receiving user (e.g. a merchant) does not have to be logged into their financial agent in order to receive payments. If the products have been setup properly on the delivery service agent servers, the receiving user (e.g. a merchant) may receive payments at any time, for goods sold, into the financial agent account associated with the receiving user.

The receiving user (e.g. a merchant) may log into the account maintenance application of the receiving user to review associated sales history, modify associated account information and/or perform any and all maintenance tasks made available through the related financial agent's account maintenance interface.

Interaction 1 of FIG. 1:

The sending user (e.g. a buyer) uses a front-end client application to access goods and/or services being offered by a receiving user (e.g. a merchant). The front-end client applications may allow presentation of goods of a receiving user for sale and may integrate with the delivery service agent servers for purchase initiation and processing. The front-end applications in general have wide scope of applicability and are not limited to the examples provided herein. Some examples include, standard Internet browsers, integrated and proprietary purchasing/catalog applications, email clients, gaming applications, VoIP clients, etc.

After a sending user initiates the purchase of the product or services, a delivery service agent is responsible for initiating an associated transaction and for verifying delivery of purchased product prior to the completion of the transaction. Depending on delivery technologies and communications protocols, this process may use a variable number of processing and communication steps.

Interaction 2 of FIG. 1:

Once a delivery service agent receives a purchase request from a sending user (e.g. a buyer) it will request a purchase authorization from the transaction servers. The delivery service agent will hold off on the delivery of the product until such time as a valid authorization is returned to it from the transaction servers. Once a purchase authorization is returned to the delivery service agent from the transaction servers, the delivery service agent will deliver the product to the sending user using whatever communication and delivery protocol is appropriate. Some examples of these protocols include HTTP, FTP and SMTP. If a denial of purchase authorization is returned from the transaction servers the delivery service agent will cancel the delivery request and present appropriate responses to the sending user (e.g. a buyer).

Once the final delivery status of the purchase has been determined the delivery service agent will notify the transaction servers as to this final delivery status (e.g. success or failure). Further communication with the delivery service agent by the transaction servers may occur for auditing purposes.

Interaction 3 of FIG. 1:

Once the transaction servers receive an authorization request from a delivery service agent they communicate with the financial agent of the sending user to obtain authorization for the purchase. If a denial of authorization is returned to the transaction server, an appropriate error will be returned to the delivery service agent denying purchase authorization for the transaction.

After delivery confirmation from the delivery service agent, the financial agent of the sending user will be notified of the completion of the transaction so that settlement may commence during the next batch settlement process.

Interaction 4 of FIG. 1:

Concurrently, or subsequent to the authorization granted by the financial agent of the sending user through interaction 3 of FIG. 1, the transaction server will contact the financial agent of the receiving user to request an authorization and validation that the receiving user can receive payment for the transaction. Upon receiving a first authorization from the financial agent of the sending user and a second authorization from the financial agent of the receiving user, the transaction server will return purchase authorization to the delivery service agent. If a denial of one of the first or second authorizations is returned to the transaction server an appropriate error will be returned to the delivery service agent denying purchase authorization for the transaction.

After delivery confirmation from the delivery service agent the financial agent of the sending user and the financial agent of the receiving user will be notified of the completion of the transaction so that settlement may commence during the next batch settlement process as discussed above.

Funds Transfer Transaction Implementation

Funds transfer transactions are processed through the system via a proprietary protocol between the associated process entities involved. FIG. 2 shows a schematic view of the relationships and general process concerning the funds transfer transaction.

Interaction A of FIG. 2:

Unlike the sending user, the receiving user does not have to be logged into the associated financial agent of the receiving user in order to receive a funds transfer. The receiving user may log into the account maintenance application of the receiving user to review their funds transfer history, sales history (if applicable), modify account information and/or perform any and all maintenance tasks made available through the account maintenance interface of the associated financial agent.

Interaction 1 of FIG. 2:

In order for a sending user (e.g. a buyer) to initiate a funds transfer they must log into the financial agent of the sending user. This login is the same login as describe above in the purchase transaction section under interaction B of FIG. 1. In addition to the ability to purchase goods, the sending user will have the additional ability to initiate a direct funds transfer to any other receiving user having an account with one of the financial agents. As mentioned above, this login also serves to authenticate the sending user and offers additional security and notification capabilities during the processing of a funds transfer transaction.

Interaction 2 of FIG. 2:

After the sending user logs into the account maintenance application of the financial agent of the sending user, the sending user may initiate a funds transfer transaction to send funds to one of the other user as a receiving user. The financial agent of the sending user will then contact the transaction servers to request funds transfer authorization. If an authorization is returned from the transaction servers the financial agent of the sending user will decrement the account of the sending user by the fund transfer amount and will include the financial settlement of the fund transfer during the next transaction settlement batch process as described above.

If a denial of authorization is returned by the transaction server the financial agent of the sending user will notify the sending user of the error and the transaction will be cancelled.

Interaction 3 of FIG. 2:

Once a funds transfer request is received by the transaction server, a request for authorization and validation of the receiving user is sent to the financial agent of the receiving user. The financial agent of the receiving user will check account validity and authorization and return an appropriate response to the transaction servers. If authorized, the financial agent of the receiving user is guaranteed payment by the financial agent of the sending user and thus the account of the receiving user may be credited immediately in the amount of the funds transfer.

Transaction Fees:

All transactions processed through the system will be subject to transaction fees by the administrator of the system. The administer of the system can be a owner and/or licensor of the system or other party. Such transaction fees will be deducted from payments to receiving users so that no change in the purchase or funds transfer amounts are seen by the sending user. All transaction fees charged by administrator of the system are removed by the financial agent of the sending user and sent directly to administrator of the system as a separate settlement transaction from the settlement with the financial agent of the receiving user.

The financial agent of the sending user is committed to not add any additional charges on top of a purchase amount, as this may harm or interfere with the standardized market space of the administrator of the system. Thus, all sending users of funds either through a funds transfer or product purchase will be guaranteed to only have the actual transaction amount deducted from the accounts of the sending users. The receiving user will bear the entire cost of the transaction.

The system has been presented herein by way of particular example and also be abstraction in order to facilitate a high-level view of concepts involved. The actual technical design and implementation may vary based on particular implementation while maintaining the overall nature of concepts disclosed.

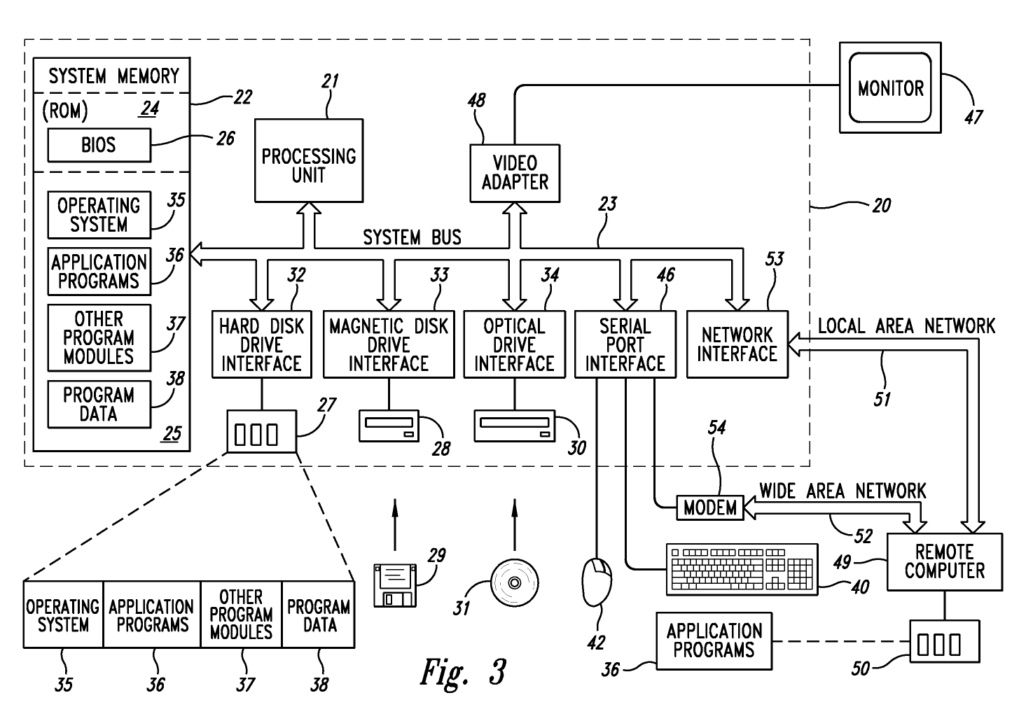

FIG. 3 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 3 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

From the foregoing it will be appreciated that, although specific implementations have been described herein for purposes of illustration, various modifications may be made without deviating from the spirit and scope of the system.

The invention claimed is:

1. A method comprising:
communicating with a first financial agent regarding at least one financial transaction notification, the first financial agent being in communication with a user receiver regarding user receiver bank account management;
communicating with a second financial agent regarding purchase authorization and financial notification, the second financial agent being in communication with a user sender regarding the user sender bank account management;
communication with a delivery service agent regarding authorization request and delivery confirmation, the delivery service agent being in communication with the user receiver regarding vendor product inventory, the delivery service agent being in communication with the user sender regarding consumer product purchase and delivery; and
receiving settlement fees from the second financial agent, the second financial agent sending an electronic settlement to the first financial agent.

2. A method comprising:
communicating with a first financial agent regarding receiver account verification and funds transfer authorization, the first financial agent being in communication with a user receiver;
communicating with a second financial agent regarding receiver account verification and funds transfer authorization, the second financial agent being in communication with a user sender; and
receiving settlement fees from the second financial agent, the second financial agent sending an electronic settlement to the first financial agent.
